(19) United States
(12) Patent Application Publication
(10) Pub. No.: US 2006/0139725 A1
(43) Pub. Date: Jun. 29, 2006

(54) Electrochromic device

(75) Inventors: Ji-Jung Kai, Hsinchu City (TW); Fu-Rong Chen, Hsinchu City (TW); Chia-Ching Liao, Taipei City (TW); Keng-Che Cheng, Hsinchu City (TW)

Correspondence Address: RAYMOND Y. CHAN, 108 N. YNEZ AVE., SUITE 128, MONTEREY PARK, CA, 91754, US

(73) Assignee: Tsinghua Nano-Technology Co., Ltd.

(21) Appl. No.: 11/027,462

(22) Filed: Dec. 29, 2004

(51) Int. Cl. G02F 1/15

(52) U.S. Cl. 359/265

(57) ABSTRACT

A method of manufacturing an electrochromic device, which includes the steps of: (a) forming a plurality of nano-electrochromic elements on a transparent conductor of a transparent conductor substrate, wherein the nano-electrochromic elements are bonded together to form an electrochromic layer on the transparent conductor substrate so as to define a reaction surface of the electrochromic layer; (b) applying an electrolyte on the electrochromic layer; and (c) electrolyzing the electrolyte such that ions in the electrolyte are displaced into the electrochromic layer through the reaction surface thereof to alter an optical characteristic of the electrochromic elements.

### BACKGROUND OF THE PRESENT INVENTION

1. Field of Invention

The present invention relates to an electrochromic device, and more particularly to a method of fabricating an electrochromic device, wherein an electrochromic layer is made by a plurality of nano-electrochromic elements bonded together to provide maximum reaction surface area for an optimal electrochromic process.

2. Description of Related Arts

Electrochromism was conceptualized in 1961 and is generally accepted as a phenomenon in which a color of a particular electrochromic material may be varied upon an application of potential difference therebetween. As such, the optical performance of the electrochromic material upon impinged by electromagnetic radiation, such as a predetermined amount of visible light, is rendered different from that of the electrochromic material which is not subject to electrochromism. For example, an electrochromic device, when subject to visible light, may substantially prevent light of predetermined wavelengths from pass therethrough, so as to block, say, excessive light from reaching the other side of the electrochromic device.

A conventional electrochromic device comprises first transparent conductor substrate, an electrochromic layer, an ions storage layer, an electrolyte layer, and second transparent conductor substrate. The electrolyte layer is disposed between the electrochromic layer and the ion storage layer and the electrochromic layer is arranged to be subjected to a predetermined amount of potential difference in such a manner to achieve a desirable optical characteristic of the electrochromic device.

Typically, the first and the second transparent conductor substrate are fabricated by glass, but exceptionally, plastics materials may be utilized for use in different applications. The electrochromic layer can be embodied as either an organic or an inorganic compound. Typical organic chemicals include viologen and pyrodine, whereas typical inorganic compounds include tungsten trioxide (WO₃), MoO₃, or V₂O₅. On the ther hands, the electrolyte layer is embodied as a predetermined solution in which lithium chloride and perchlorate is chemically added. Depending on various optical characteristics possessed by electrochromic device, it may be utilized as forming a smart window, anti-dazzling rear view mirrors, vehicle sun roof, static display device, and the likes.

A common discrepancy for the above-mentioned conventional electrochromic devices is that they are generally suffer from short life span, chemically instable, and fairly long reaction time due to an uneven chemical reaction between the electrochromic layer and electrolyte layer.

From technical perspective, the variation of optical characteristic is accomplished by applying a predetermined amount of potential difference between the first and second transparent conductor substrate, in which cations from the electrolyte layer are displaced to the electrochromic layer in accordance with a predetermined chemical reaction. As a result, a change of the optical characteristic in the electrochromic layer largely governed by the amount to which and the distribution of which the cations displace to the electrochromic layer.

There exist handfuls of developments in this field for overcoming the above-mentioned discrepancies. For example, Japan Patent No. 51-23110 of Kokai discloses an electrochromic layer having a plurality of meshes so as to increase a reaction surface area of the electrochromic layer with the corresponding electrolyte for speeding up the reaction rate.

Moreover, U.S. Pat. No. 6,301,038 of Donald Fitzmaurice discloses an electrochromic layer which is coated with Titanium oxide (TiO₂) for forming a plurality of holes on the layer so as to substantially increase a reaction surface area thereof. More recently, it has been disclosed in 2003 that a leading Japanese academic of Kazuyuki published a kind of electrochromic layer which has a plurality of holes formed thereon by means of aluminum oxides for increasing an effectiveness and efficiency of the electrochromism process. According to the disclosed information, the diameter of each hole was said in the range of 38 nm - 65 nm.

Yet one difficulty in the above-mentioned developments is that the smaller the holes, the more difficult they could be precisely and economically formed. Moreover, in order to generate holes of such a small diameter, expensive equipment is inevitably involved. This greatly increases the overall manufacturing cost and the ultimate selling price of the relevant electrochromic device which should be utilized in a relatively typical environment, such as the window glass of a car.

### SUMMARY OF THE PRESENT INVENTION

A main object of the present invention is to provide a method of fabricating an electrochromic device, wherein an electrochromic layer is made up of a plurality of nano-electrochromic elements bonded together to provide maximum reaction surface area for an optimal electrochromic process.

Another object of the present invention is to provide a method of fabricating an electrochromic device which is simple and efficient yet capable of substantially overcoming the above mentioned discrepancies having regard to conventional electrochromic devices.

Another object of the present invention is to provide an electrochromic device which is capable of varying an optical characteristic thereof when subject to a predetermined potential difference across the electrochromic device so as to achieve a particular application of the present invention, such as to curtail a predetermined amount of electromagnetic waves of a particular range of wavelengths (e.g. visible light of a particular color).

Another object of the present invention is to provide an electrochromic device which comprises an electrochromic layer comprising a plurality of nano-electrochromic elements which is arranged in a predetermined manner for providing a maximum surface area for electrochromic process.

Accordingly, in order to accomplish the above objects, the present invention provides a method of fabricating an electrochromic device, comprising the steps of:

(a) forming a plurality of nano-electrochromic elements on a transparent conductor substrate, wherein the nano-electrochromic elements are bonded together to form an electrochromic layer on the transparent conductor substrate so as to define a reaction surface of the electrochromic layer;

(b) applying an electrolyte on the electrochromic layer; and

(c) electrolyzing the electrolyte such that ions in the electrolyte are displaced into the electrochromic layer through the reaction surface thereof to alter an optical characteristic of the transparent conductor substrate.

Furthermore, the present invention provides an electrochromic device, comprising:

first and second transparent conductor substrate;

an electrochromic layer formed on the transparent conductor substrate, wherein the electrochromic layer comprises a plurality of nano-electrochromic elements bonded together to define a reaction surface of the electrochromic layer; and

an electrolyte applied on the electrochromic layer such that ions in the electrolyte are displaced into the electrochromic layer through the reaction surface thereof to alter the optical characteristic of the electrochromic layer when the first and second transparent conductorare subject to a predetermined potential difference.

These and other objectives, features, and advantages of the present invention will become apparent from the following detailed description, the accompanying drawings, and the appended claims.

### BRIEF DESCRIPTION OF THE DRAWINGS

FIG. 1 is a flow diagram of a method of fabricating an electrochromic device according to a preferred embodiment of the present invention.

FIG. 2 is a flow diagram of the method of forming the electrochromic layer according to the above preferred embodiment of the present invention.

FIG. 3 is microscopic diagram of the electrochromic layer according to the above preferred embodiment of the present invention, illustrating that a plurality of nano-electrochromic elements are formed.

FIG. 4 is an electrochromic device according to the above preferred embodiment of the present invention.

FIG. 5 is a schematic diagram of an electrochromic furnace according to the above preferred embodiment of the present invention.

FIG. 6 illustrates a first alternative mode of the electrochromic device according to the above preferred embodiment of the present invention.

### DETAILED DESCRIPTION OF THE PREFERRED EMBODIMENT

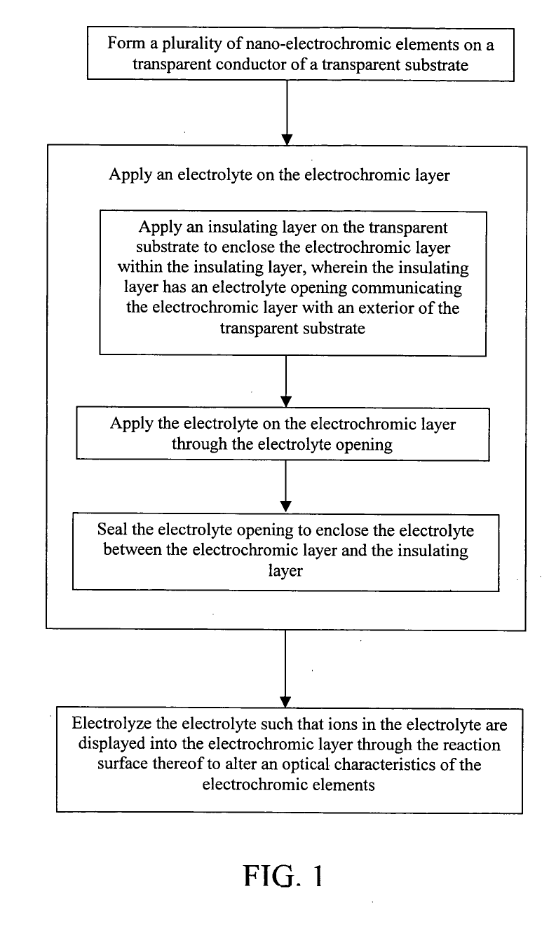

Referring to FIG. 1 of the drawings, a method of manufacturing an electrochromic device 1 according to a preferred embodiment of the present invention is illustrated, wherein the manufacturing method comprises the steps of:

(a) forming a plurality of nano-electrochromic elements on a transparent conductor substrate, wherein the nano-electrochromic elements are bonded together to form an electrochromic layer on the transparent conductor substrate so as to define a reaction surface of the electrochromic layer;

(b) applying an electrolyte on the electrochromic layer; and

(c) electrolyzing the electrolyte such that ions in the electrolyte are displaced into the electrochromic layer through the reaction surface thereof to alter an optical characteristic of the nano-electrochromic elements.

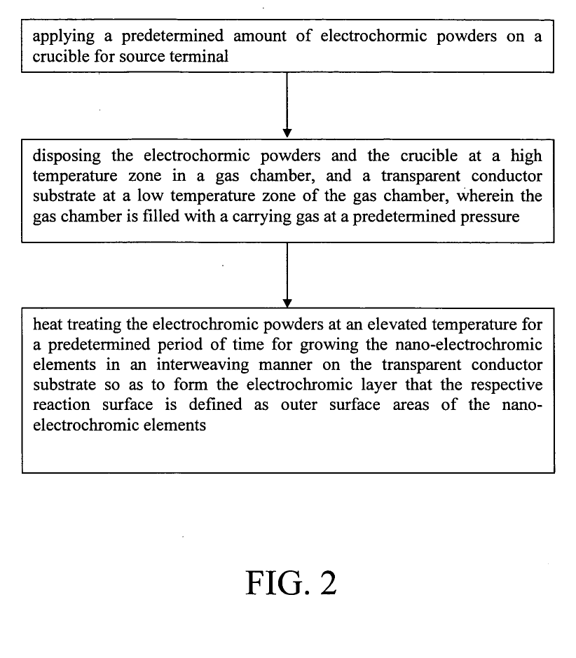

Referring to FIG. 2 of the drawings, the step (a) above comprises the steps of:

(a.1) applying a predetermined amount of electrochormic powders on a crucible for source terminal;

(a.2) disposing the electrochormic powders and the crucible at a high temperature zone in a gas chamber, and a transparent conductor substrate at a low temperature zone of the gas chamber, wherein the gas chamber is filled with a carrying gas at a predetermined pressure; and

(a.3) heat treating the electrochromic powders at an elevated temperature for a predetermined period of time for growing the nano-electrochromic elements in an interweaving manner on the transparent conductor substrate so as to form the electrochromic layer that the respective reaction surface is defined as outer surface areas of the nano-electrochromic elements.

According to the preferred embodiment, the electrochromic layer is formed on the transparent conductor substrate, wherein the electrochromic layer comprises a plurality of nano-electrochromic elements bonded together to define a reaction surface of the electrochromic layer.

According to the preferred embodiment, the transparent conductor substrate which is utilized in the above-mentioned steps is embodied as glass or transparent plastic materials such as composite materials which are transparent in optical characteristic. Specifically, the transparent conductor substrate is preferably embodied as glass which is combined with indium tin oxide, or zinc oxide doped aluminum.

Moreover, the electrolyte is applied on the electrochromic layer such that ions in the electrolyte are displaced into the electrochromic layer through the reaction surface thereof to alter the optical characteristic of the nano-electrochromic elements when the transparent conductor substrates are subject to a predetermined potential difference.

When a predetermined potential difference is applied to the transparent conductor of the transparent conductor substrate, cations in the electrolyte would be displaced to the electrochromic layer through the reaction surface. By altering the optical characteristic of the nano-electrochromic elements, the optical characteristic of the entire electrochromic device is also altered to fit a particular application. For example, light of particular wavelength in the electromagnetic spectrum may be substantially blocked by the electrochromic layer.

Accordingly, the transparent conductor, which is preferably made of indium tin oxide (ITO), is sputter coated on the surface of the transparent conductor substrate for electrolyzing process. It is worth mentioning that the transparent conductor forms as an electrode end of the electrochromic layer to display the ions of the electrolyte within the electrochromic layer.

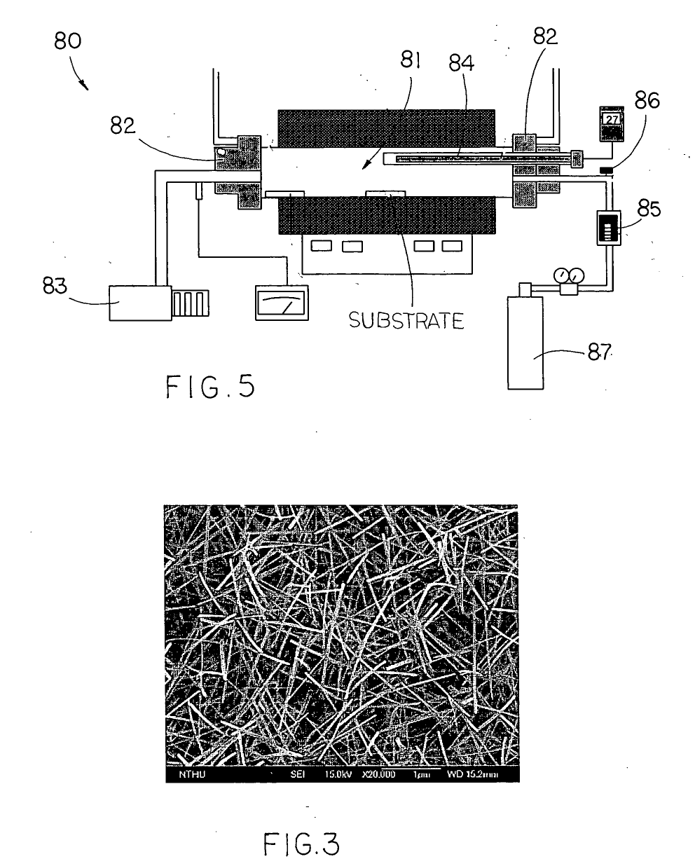

In step (a.2) above, the carrying gas is embodied as a predetermined amount of argon gas, a mixture of argon gas and oxygen or nitrogen gas. Referring to FIG. 3 of the drawings, a microscopic diagram of the electrochromic layer is illustrated, in which the plurality of nano-electrochromic elements is formed in an interwoven manner to define the reaction surface thereof. Alternatively, the electrochromic powders can be tungsten oxide, vanadium oxide, and other transitional metals oxides. In any event, it is worth pointing out while that the carrying gas is not a must, the presence of it would substantially increase the performance of the electrochromic layer growing step, as in the step (a.3).

Referring to FIG. 5 of the drawings, the step (a) is performed by an electrochromic furnace 80 comprising a central gas chamber 81, two sealing caps 82 provided at two ends of the central gas chamber 81 for thermally sealing the central gas chamber 81 wherein a thermometer 84 is disposed in the central gas chamber 81 for measuring the temperature therewithin, a vacuum pump unit 83 communicated with the central gas chamber 81 via one of the sealing caps 82 through a flow-meter 85 for vacuuming air inside the central gas chamber 81 via a gas valve 86, and a carrying air stored in a gas tank 87 input which is also communicated with the central gas chamber 81 via another sealing cap 82 for pumping the carrying gas into the central gas chamber 81.

According to the preferred embodiment, the above-mentioned step (a) is performed in the central gas chamber 81 for forming the electrochromic layer which is then fed with cations from the electrolyte such that the optical characteristic of the electrochromic layer can be deliberately varied in order to perform different applications.

Accordingly, the gas chamber has a high temperature zone for placing electrochromic powder, and a low temperature zone for placing the transparent conductor substrate. The gas chamber 81 is filled with a carrying gas at a predetermined pressure in order to facilitate forming of the electrochromic layer.

It is worth mentioning that the elevated temperature mentioned in step (a.3) above is determined from a range of temperature, and depends on such factors as the kind of transparent conductor substrate utilized, the composition of the carrying gas, and the kind of electrochromic powders which are utilized to form the electrochromic layer.

The electrochromic powders is disposed on the conductor at the high temperature zone in the gas chamber 81, which has the elevated temperature in the range of 600° C. to 1000° C. The transparent conductor substrate is positioned within the low temperature zone of the gas chamber having the temperature in the range of 150° C. to 650° C.

In step (b) above, the electrolyte is preferably embodied as LiClO₄ in propylene carbonate. Alternative electrolytes include poly 2-acrylamido-2-methyl proane sulfonic acid (PAMSA), in which cations therefrom are arranged to displace into the electrochromic layer in the step (c) above. Yet moreover, electrolyte is typically moderately concentrated acid (H₂SO₄, HCI), a mixture of the acids with glycerol, and lithium perchlorate solutions, which were applied as liquid electrolytes, and poly(perfluoroalkylene) sulfonic acid (NAFION) as polymeric electrolytes, and the solid electrolyte such as oxides, e.g. ZrO₂, HfO₂, Ta₂O₅, SrO₂, and fluorides (salts), e.g. CaF₂, MgF₂, and CeF₂. Step (b) comprises the steps of:

(b.1) peripherally applying an insulating material on the transparent conductor substrate, wherein the insulating material defines an electrolyte opening thereon;

(b.2) applying an electrolyte on the electrochromic layer on the transparent conductor substrate via the electrolyte opening; and

(b.3) sealing the electrolyte opening by a sealing material.

In step (c) above, it comprises a step of applying a potential difference through the transparent conductor substrate so as to electrolyze the electrolyte thereon in which cations contained in the electrolyte is arranged to displace to the electrochromic layer via the reaction surface for altering an optical characteristic, such as a transmitivity of a particular spectrum of electromagnetic wave.

According to the preferred embodiment, the insulating material is preferably embodied as being fabricated by glass or plastic materials. On the other hand, the sealing material is embodied as regular adhesive material such as epoxy and silicone.

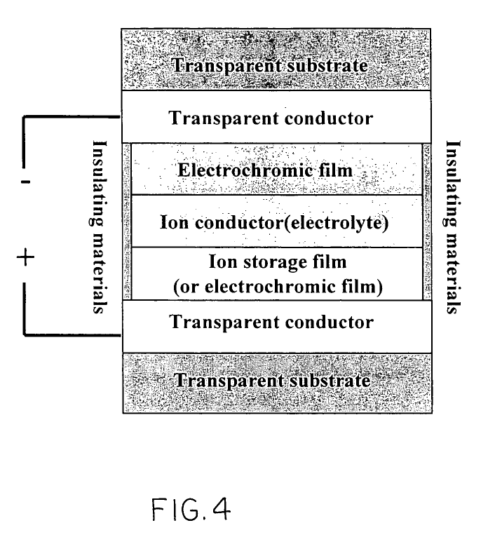

As shown in FIG. 4, the electrochromic device is arranged to form a window structure as one of the applications. Accordingly, two transparent conductor substrates are used to sandwich the electrochromic layer, which is embodied as an electrochromic film, wherein when a potential difference at the two transparent conductor substrates, cations in the electrolyte would be displaced to the electrochromic layers through the reaction surfaces thereof so as to ultimately alter an optical characteristic of the electrochromic device. In other words, the electrochromic layers are sandwiched between the two transparent conductor substrates while the electrolyte is sandwiched between the two electrochromic layers such that the cations in the electrolyte are displaced to the electrochromic layers when the potential difference is applied to the transparent conductors.

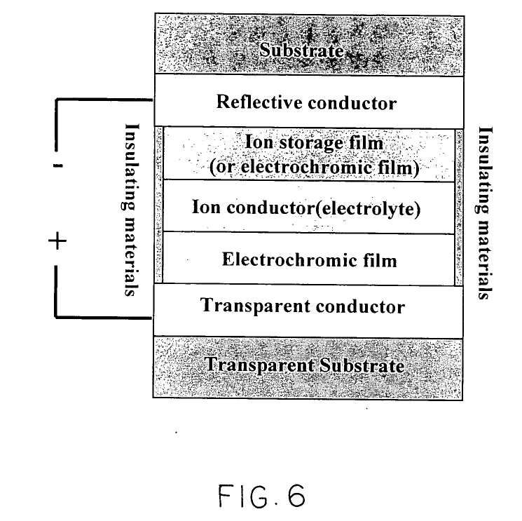

Referring to FIG. 6 of the drawings, a first alternative mode of the electrochromic layer according to the above preferred embodiment of the present invention is illustrated. The first alternative mode is similar to that of the preferred embodiment except that the electrochromic device is used as a mirror as another application. As shown in FIG. 6, one of the transparent conductors is substituted as a reflective conductor such that the light can be reflected by the reflective conductor.

From the forgoing discussion, it can be appreciated that the increased reaction surface area substantially enhances the reaction performance between the electrochromic layer and the electrolyte, in terms of effectiveness and efficiency. Moreover, no complicated instruments are involved and as a result, an economical method in forming the electrochromic device is accomplished.

In other words, without violating the spirit of the present invention, the present invention also provides an electrochromic device, comprising a transparent conductor substrate; an electrochromic layer formed on the transparent conductor substrate, wherein the electrochromic layer comprises a plurality of nano-electrochromic elements bonded together to define a reaction surface of the electrochromic layer; and an electrolyte applied on the electrochromic layer such that ions in the electrolyte are displaced into the electrochromic layer through the reaction surface thereof to alter the optical characteristic of the electrochromic layer when the first and second transparent conductor substrates is subject to a predetermined potential difference.

Accordingly, the electrochromic layer further comprises a predetermined amount of electrochromic powders applied on the crucible. When the crucible is heated up at an elevated temperature, the electrochromic powders are evaporated and formed the nano-electrochromic elements in an interweaving manner on the transparent conductor substrate so as to form the electrochromic layer that the respective reaction surface is defined as outer surface areas of the nano-electrochromic element.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of manufacturing an electrochromic device, comprising the steps of:
(a) forming a plurality of nano-electrochromic elements on a transparent conductor substrate, wherein said nano-electrochromic elements are bonded together to form an electrochromic layer on said transparent conductor substrate so as to define a reaction surface of said electrochromic layer;
(b) applying an electrolyte on said electrochromic layer; and
(c) electrolyzing said electrolyte such that ions in said electrolyte are displaced into said electrochromic layer through said reaction surface thereof to alter an optical characteristic of said electrochromic elements.

2. The method as recited in claim 1, in step (a), further comprising the steps of:
(a.1) applying a predetermined amount of electrochromic powders on a crucible for source terminal;
(a.2) disposing said electrochromic powders and said crucible at a high temperature zone in a gas chamber, and said transparent conductor substrate at a low temperature zone of said gas chamber, wherein said gas chamber is filled with a carrying gas at a predetermined pressure; and
(a.3) heat treating said electrochromic powders to evaporate at an elevated temperature for a predetermined period of time for growing said nano-electrochromic elements in an interweaving manner on said transparent conductor substrate so as to form said electrochromic layer that said respective reaction surface is defined as outer surface areas of said nano-electrochromic elements.

3. The method as recited in claim 1, in step (b), further comprising the steps of:
(b.1) applying an insulating layer on said transparent conductor substrate to enclose said electrochromic layer within said insulating layer, wherein said insulating layer has an electrolyte opening communicating said electrochromic layer with an exterior of said transparent conductor substrate;
(b.2) applying said electrolyte on said electrochromic layer through said electrolyte opening; and
(b.3) sealing said electrolyte opening to enclose said electrolyte between said electrochromic layer and said insulating layer.

4. The method as recited in claim 2, in step (b), further comprising the steps of:
(b.1) applying an insulating layer on said transparent conductor substrate to enclose said electrochromic layer within said insulating layer, wherein said insulating layer has an electrolyte opening communicating said electrochromic layer with an exterior of said transparent conductor substrate;
(b.2) applying said electrolyte on said electrochromic layer through said electrolyte opening; and
(b.3) sealing said electrolyte opening to enclose said electrolyte between said electrochromic layer and said insulating layer.

5. The method, as recited in claim 2, wherein said electrochromic powders are made of material selected from transition oxide groups of tungsten oxide, molybdenum oxide, vanadium oxide and other transition metal oxides.

6. The method, as recited in claim 3, wherein said electrochromic powders are made of material selected from transition oxide groups of tungsten oxide, molybdenum oxide, vanadium oxide and other transition metal oxides.

7. The method, as recited in claim 4, wherein said electrochromic powders are made of material selected from a transition oxides group of tungsten oxide, molybdenum oxide, and vanadium oxide.

8. The method, as recited in claim 1, wherein said electrolyte is made of material selected from LiClO₄ in propylene carbonate, and poly 2-acrylamido-2-methyl proane sulfonic acid.

9. The method, as recited in claim 6, wherein said electrolyte is made of material selected from LiClO₄ in propylene carbonate, and poly 2-acrylamido-2-methyl proane sulfonic acid.

10. The method, as recited in claim 7, wherein said electrolyte is made of material selected from LiClO₄ in propylene carbonate, and poly 2-acrylamido-2-methyl proane sulfonic acid.

11. An electrochromic device, comprising:
first and second transparent conductor substrate;
an electrochromic layer formed on said transparent conductor substrate, wherein said electrochromic layer comprises a plurality of nano-electrochromic elements bonded together to define a reaction surface of said electrochromic layer; and
an electrolyte applied on said electrochromic layer such that ions in said electrolyte are displaced into said electrochromic layer through said reaction surface thereof to alter said optical characteristic of said electrochromic layer when said transparent conductor substrate is subject to a predetermined potential difference.

12. The electrochromic device, as recited in claim 11, wherein said electrochromic layer further comprises a predetermined amount of electrochromic powders applied on said crucible such that when said crucible is heated up at an elevated temperature, said electrochromic powders are transformed into said nano-electrochromic elements in an interweaving manner on said transparent conductor substrate so as to form said electrochromic layer that said respective reaction surface is defined as outer surface areas of said nano-electrochromic elements.

13. The electrochromic device, as recited in claim 11, wherein said electrochromic powders are made of material selected from transition oxide groups of tungsten oxide, molybdenum oxide, vanadium oxides, titanium oxide, niobium oxide, cerium oxide, cobalt oxide, tantalum oxide, chromium oxide, manganese oxide, iron oxide, ruthenium oxide, rhodium oxide, and iridium oxide.

14. The electrochromic device, as recited in claim 12, wherein said electrochromic powders are made of material selected from transition oxide groups of tungsten trioxides, molybdenum oxide, vanadium oxide, titanium oxide, niobium oxide, cerium oxide, cobalt oxide, tantalum oxide, chromium oxide, manganese oxide, iron oxide, ruthenium oxide, rhodium oxide, iridium oxide.

15. The electrochromic device, as recited in claim 11, wherein said electrolyte is made of material selected from LiCIO₄ in propylene carbonate, and poly 2-acrylamido-2-methyl proane sulfonic acid.

16. The electrochromic device, as recited in claim 13, wherein said electrolyte is made of material selected from LiCIO₄ in propylene carbonate, and poly 2-acrylamido-2-methyl proane sulfonic acid.

17. The electrochromic device, as recited in claim 14, wherein said electrolyte is made of material selected from of LiClO₄ in propylene carbonate, and poly 2 -acrylamido-2-methyl proane sulfonic acid.

18. The electrochromic device, as recited in claim 16, further comprising an insulating layer formed on said electrochromic layer to sealedly enclose said electrolyte between said electrochromic layer and said insulating layer.

19. The electrochromic device, as recited in claim 17, further comprising an insulating layer formed on said electrochromic layer to sealedly enclose said electrolyte between said electrochromic layer and said insulating layer.

20. The electrochromic device, as recited in claim 11, wherein said electrochromic layer is manufactured by the steps of:
(a.1) applying a predetermined amount of electrochromic powders on a crucible for source terminal;
(a.2) disposing said electrochromic powders and said crucible at a high temperature zone in a gas chamber, and said transparent conductor substrate at a low temperature zone of said gas chamber, wherein said gas chamber is filled with a carrying gas at a predetermined pressure; and
(a.3) heat treating said electrochromic powders to evaporate at an elevated temperature for a predetermined period of time for growing said nano-electrochromic elements in an interweaving manner on said transparent conductor substrate so as to form said electrochromic layer that said respective reaction surface is defined as outer surface areas of said nano-electrochromic elements.
